(19) United States
(12) Patent Application Publication
(10) Pub. No.: US 2020/0380845 A1
(43) Pub. Date: Dec. 3, 2020

(54) DATA COLLECTION CHECKING DEVICE OF INDUSTRIAL MACHINE

(71) Applicant: FANUC CORPORATION, Yamanashi (JP)

(72) Inventors: Nao ONOSE, Yamanashi (JP); Mitsuru MOCHIZUKI, Yamanashi (JP)

(73) Assignee: FANUC CORPORATION, Yamanashi (JP)

(21) Appl. No.: 16/857,275

(22) Filed: Apr. 24, 2020

(30) Foreign Application Priority Data
May 31, 2019 (JP) 2019-102985

(51) Int. Cl. G08B 21/18

(52) U.S. Cl. CPC G08B 21/18

(57) ABSTRACT

A data collection checking device of an industrial machine which performs checking of a data collection status when data of the industrial machine are being collected in a data collecting device, includes: a display unit that displays an object indicating the industrial machine; a data display control unit that displays, on the display unit, a virtual object indicating the data which are collectable in the industrial machine; an operation determining unit that determines operation of an operator with respect to the virtual object indicating the data displayed on the display unit, and identifies the data; a collection history acquiring unit that acquires a collection history of the identified data; and a collection history display control unit that displays, on the display unit, the collection history of the acquired data.

This application is based on and claims the benefit of priority from Japanese Patent Application No. 2019-102985, filed on 31 May, 2019, the content of which is incorporated herein by reference.

### BACKGROUND OF THE INVENTION

### Field of the Invention

The present invention relates to a data collection checking device of an industrial machine.

### Related Art

A data collection system that collects various data of a plurality of industrial machines intensively in a data collecting device is known (e.g., refer to Japanese Unexamined Patent Application, Publication No. 2018-173858).

Patent Document 1: Japanese Unexamined Patent Application, Publication No. 2018-173858

### SUMMARY OF THE INVENTION

Thus, in the field of data collection of such an industrial machine, it is desirable for checking to be intuitively and simply carried out on the data collection status as to which industrial machine data is collected. intuitively and simply.

A data collection checking device of an industrial machine according to the present disclosure which performs checking of a data collection status when data of the industrial machine are being collected in a data collecting device, includes: a display unit that displays an object indicating the industrial machine; a data display control unit that displays, on the display unit, a virtual object indicating the data which are collectable in the industrial machine; an operation determining unit that determines operation of an operator with respect to the virtual object indicating the data displayed on the display unit, and identifies the data; a collection history acquiring unit that acquires a collection history of the identified data; and a collection history display control unit that displays, on the display unit, the collection history of the acquired data.

Another data collection checking device of an industrial machine according to the present disclosure which performs checking of a data collection status when data of the industrial machine are being collected in a data collecting device, includes: a display unit that displays augmented reality in which virtual reality is superimposed on the real world; an industrial machine identifying unit that identifies the industrial machine in the real world displayed on the display unit; a data display control unit that displays, on the display unit, a virtual object relating to the data which are collectable in the industrial machine identified by the industrial machine identifying unit; an operation determining unit that determines an operation of an operator with respect to a virtual object indicating the data displayed on the display unit, and identifies the data; a collection history acquiring unit that acquires a collection history of the identified data; and a collection history display control unit that displays, on the display unit, the collection history of the acquired data.

Another data collection checking device of an industrial machine according to the present disclosure which performs checking of a data collection status when data of the industrial machine are being collected in a data collecting device, includes: a display unit that displays augmented reality in which virtual reality is superimposed on the real world; an industrial machine identifying unit that identifies the industrial machine in the real world displayed on the display unit; a collection history acquiring unit that acquires a collection history of the data that is being collected in the industrial machine identified by the industrial machine identifying unit; a data display control unit that displays, on the display unit, a virtual object relating to the data acquired by the collection history acquiring unit; an operation determining unit that determines operation of an operator with respect to avirtual object indicating the data displayed on the display unit, and identifies the data; and a collection history display control unit that displays, on the display unit, a collection history of the data identified by the operation determining unit on a basis of the collection history of the data acquired by the collection history acquiring unit.

According to the present disclosure, in the field of data collection of such an industrial machine, it is possible to intuitively and simply carry out the checking of the data collection status as to which industrial machine data is collected.

### BRIEF DESCRIPTION OF THE DRAWINGS

FIG. 1 is a diagram showing the configuration of a data collection system including a data collection checking device of a machine tool according to a first embodiment;

FIG. 2 is a diagram showing an example of a display by the data collection checking device of the machine tool according to the first embodiment;

FIG. 3 is a diagram showing a flowchart of data collection checking operation by the data collection checking device of the machine tool according to the first embodiment;

FIG. 4 is a diagram showing a configuration of a data collection system including the data collection checking device of a machine tool according to the second embodiment;

FIG. 5 is a diagram showing an example of a display by the data collection checking device of the machine tool according to the second embodiment;

FIG. 6 is a diagram showing a flowchart of data collection checking operation by the data collection checking device of the machine tool according to the second embodiment;

FIG. 7 is a diagram showing an example of a display by the data collection checking device of the machine tool according to a modification example of the second embodiment;

FIG. 8 is a diagram showing an example of a display by the data collection checking device of the machine tool according to the modification example of the second embodiment;

FIG. 9 is a diagram showing an example of a display by the data collection checking device of the machine tool according to the modification example of the second embodiment;

FIG. 10 is a diagram showing a flowchart of the data collection checking operation by the data collection checking device of the machine tool according to the modification example of the second embodiment; and

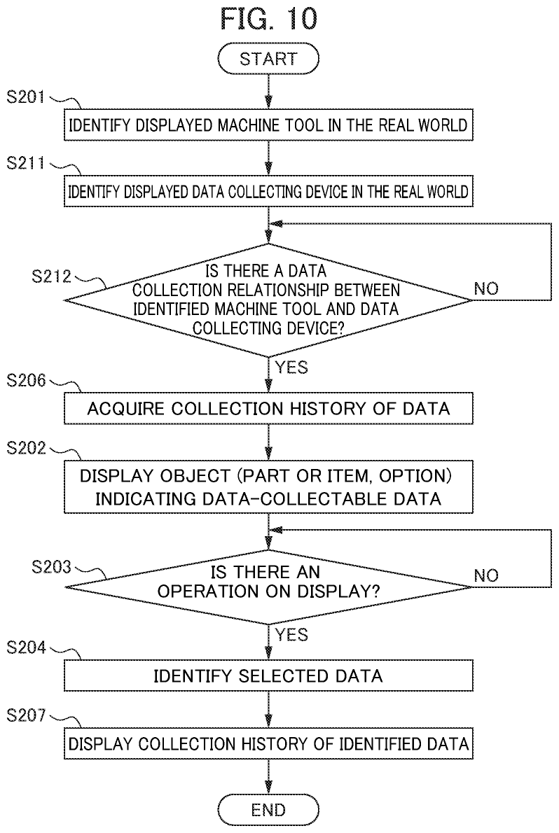

FIG. 11 is a diagram showing an example of a display by the data collection checking device of the machine tool according to the modification example of the second embodiment.

### DETAILED DESCRIPTION OF THE INVENTION

Hereinafter, a description will be given of an example of an embodiment of the present invention with reference to the accompanying drawings. It should be noted that the same reference numerals will be given to the same or equivalent parts in the drawings.

### First Embodiment

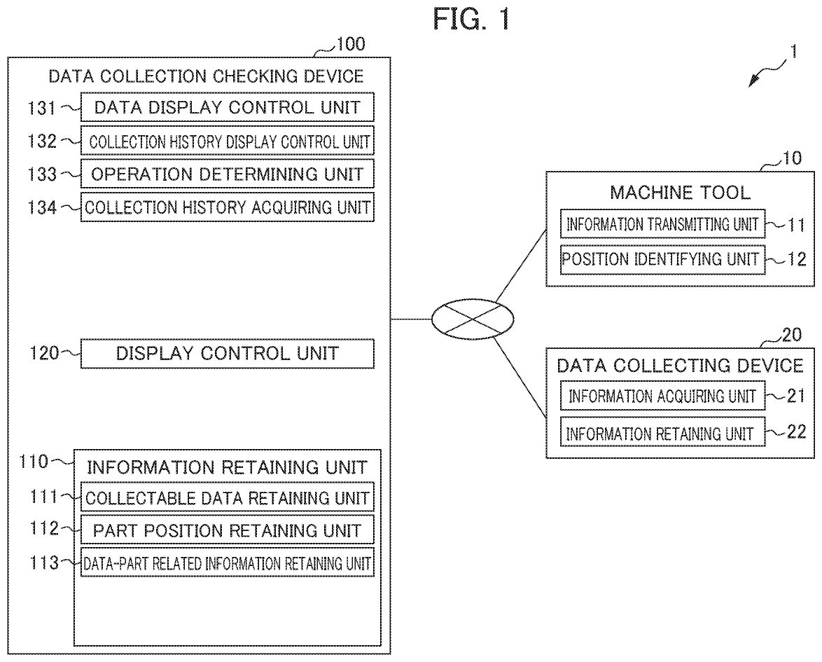

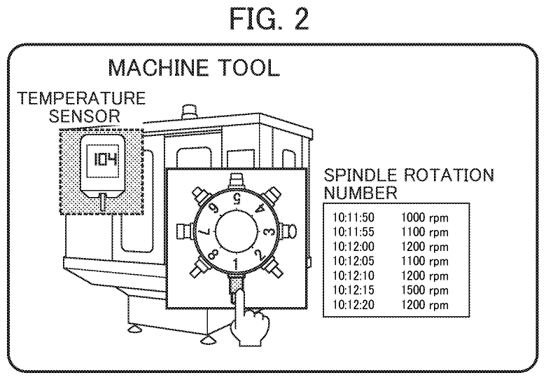

FIG. 1 is a diagram showing a configuration of a data collection system including a data collection checking device of a machine tool according to a first embodiment. FIG. 2 is a diagram showing an example of a display splay by the data collection checking device of the machine tool according to the first embodiment. In the data collection system 1 shown in FIG. 1, a plurality of machine tools 10, a data collecting device 20, and the data collection checking device 100 are connected by a wired or wireless network such as LAN and WAN, or short-range communication such as Bluetooth and Wi-Fi.

The machine tool 10 is, for example, a device for performing predetermined machining by numerical control. The machine tool 10 includes an information transmitting unit 11 and a position identifying unit 12.

The information transmitting unit 11 transmits various kinds of data that are collectable (data-collectable data) of the machine tool in a data collecting device 20. Examples of the data-collectable data include the temperature of a temperature sensor, data of a vibration sensor, spindle rotation number, control axis rotation number, tool life, numerical control data, circuity information of a programmable logic controller, load current, energization time, and machined part number. The position identifying unit 12 retains the position information of the machine tool.

The data collecting device 20 is, for example, a host computer. The data collecting device 20 collects data of the machine tool 10. The data collecting device 20 includes an information acquiring unit 21 and an information retaining unit 22.

The information acquiring unit 21 collects data from the machine tool 10. The information retaining unit 22 retains the data of the machine tool 10 acquired by the information acquiring unit 21.

The data collection checking device 100 checks the data collection status of which machine tool 10 the data is collected in the data collecting device 20. The data collection checking device 100 is, for example, an information processing device such as a smartphone, a tablet, a PC, or the like. The data collection checking device 100 includes an information retaining unit 110, a display operating unit 120, a data display control unit 131, a collection history display control unit 132, an operation determining unit 133, and a collection history acquiring unit 134.

The data collection checking device 100 (excluding the information retaining unit 110 and the display operating unit 120) is composed of an arithmetic processor such as a DSP (Digital Signal Processor) and an FPGA (Field Programmable Gate Array). The various functions of the data collection checking device 100 (excluding the information retaining unit 110 and the display operating unit 120) are realized by executing predetermined software (program, application) stored in a storage unit, for example. The various functions of the data collection checking device 100 (excluding the information retaining unit 110 and the display operating unit 120) may be realized by cooperation between hardware and software, or may be realized only by hardware (electronic circuit).

The information retaining unit 110 is, for example, rewritable memory such as EEPROM, or a rewritable disk such as an HDD (Hard Disk Drive) or SSD (Solid State Drive). The information retaining unit 110 includes a collectable data retaining unit 111, a part position retaining unit 112, and a data-part related information retaining unit 113.

The collectable data retaining unit 111 retains data-collectable data for each machine tool. Examples of the data-collectable data include the temperature of the temperature sensor, data of the vibration sensor, the spindle rotation number, the control axis rotation number, the tool life, the numerical control data, and the circuit information of the programmable logic controller.

The part position retaining unit 112 retains the position of the part corresponding to the data-collectable data for each machine tool. Examples of the parts corresponding to the data-collectable data include the temperature sensor, the vibration sensor, various motors, tools, a coolant storage, IO devices, and a machined product.

The data-part related information retaining unit 113 retains, for each machine tool, the data-part related. information in which the data retained by the collectable data retaining unit 111 is associated with the position of the part corresponding to the data-collectable data retained by the part position retaining unit 112.

The display operating unit 120 includes a display device such as a liquid crystal display, and displays, for example, a WEB screen. The display operating unit 120 displays an object indicating the machine tool or the data collecting device.

In addition, the display operating unit 120 includes an operation device such as a touch panel, and detects operation by an operator.

The data display control unit 131 displays or displays in a highlighted manner, on the display operating unit 120, an object indicating data-collectable data in a machine tool on the basis of the data-collectable data retained in the collectable data retaining unit 111, the position of a part corresponding to the data-collectable data retained in the part position retaining unit 112, and the data-part relation information retained in the data-part, related information retaining unit 113 (refer to FIG. 2). Examples of the object indicating data-collectable data include an object indicating a part corresponding to data, an item of data, an option of the item of the data, and the like.

The collection history display control unit 132 displays, on the display operating unit 120, the collection history of the data of the machine tool acquired by the collection history acquiring unit 134.

The operation determining unit 133 determines the operation of the operator with respect to the object indicating the data of the machine tool displayed on the display operating unit 120 to identify the data selected by the operator.

The collection history acquiring unit 134 acquires the collection history (including the collection time information) of identified data from the machine tool or the data collecting device.

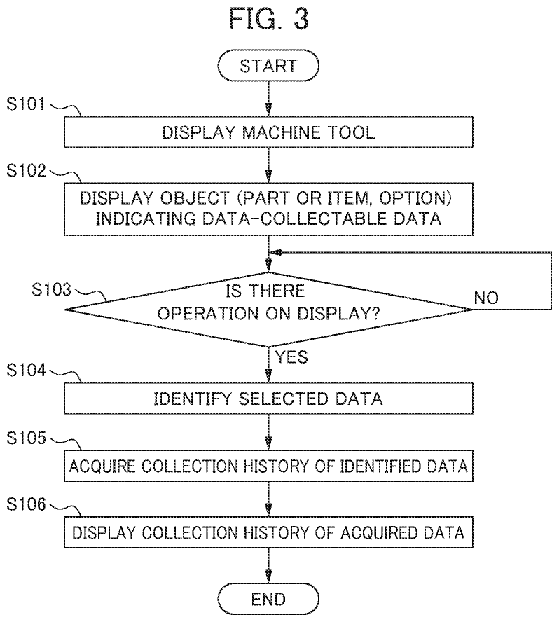

Next, with reference to FIG. 3, a description will be given of a data collection checking operation by the data collection checking device of the machine tool according to the present embodiment. FIG. 3 is a flowchart of the data collection checking operation by the data collection checking device of the machine tool according to the present embodiment.

First, the display operating unit 120 displays an object of a desired machine tool (S101). Next, the data display control unit 131 displays, on the display operating unit 120, a virtual object relating to data-collectable data in a machine tool on the basis of the data-collectable data retained in the collectable data retaining unit 111, the position of a part corresponding to the data-collectable data retained in the part position retaining unit 112, and the data-part relation information retained in the data-part related information retaining unit 113 (S102).

In the example of FIG. 2, in a case in which the temperature (data) of the temperature sensor (part) in the machine tool can be collected, in the machine tool in the real world, the vicinity of the position of the temperature sensor is highlighted, for example, in red, and virtual objects of a temperature sensor and temperature are displayed. For example, the virtual object is displayed at a position and depth as if the temperature sensor were at a position in the real world. According to this, it is possible to easily recognize the data-collectable data intuitively by the operator.

Furthermore, in the example of FIG. 2, in a case in which the spindle rotation speed (data) in the machine tool can be collected, in the machine tool in the real world, a virtual object of a tool holder is displayed near the position of the tool (part), and the tool in use is highlighted, for example, in red. For example, the virtual object is displayed at a position and depth as if the tool or tool holder were at a position in the real world. According to this, it is possible to easily recognize the data collectable data intuitively by the operator.

Next, the operation determining unit 133 determines operation of the operator with respect to the virtual object relating to the data displayed on the display operating unit 120 (S103). If there is no operation by the operator, the processing returns to Step S103.

On the other hand, for example, the operator performs an operation of tapping a virtual object relating to desired data displayed on the display operating unit 120. Then, the operation determining unit 133 identifies the data of the machine tool selected by the operator (S104).

Next, the collection history acquiring unit 134 acquires a collection history of identified data from the machine tool 10 or a higher order system (S105).

Next, the collection history display control unit 132 displays the collection history of the acquired data to the display operating unit 120 (S106). In the example of FIG. 2, the collection history of the data is displayed near the object of the data selected by the operator. It should be noted that, in a case in which data is collected by the device performing a plurality of data collection, the collection history of these data may be combined to be displayed thereon.

As described above, the data collection checking device 100 of the machine tool of the first embodiment performs the following operations:

displaying a virtual object (a part or an item, an option) that indicates data-collectible data in a machine tool;

determining an operation of an operator with respect to the virtual object indicating the data displayed on a display unit, and identifying the data;

acquiring the collection history of the identified data; and

displaying the collection history of the acquired data.

Thus, for example, it is possible for the operator to check a data collection history of a machine tool, i.e. a data collection status of which machine tool data is collected in a data collecting device simply by performing intuitive and simple operation such as selecting data of a desired industrial machine displayed on the display unit.

### Second Embodiment

In the second embodiment, a data collection checking device having an AR function is exemplified.

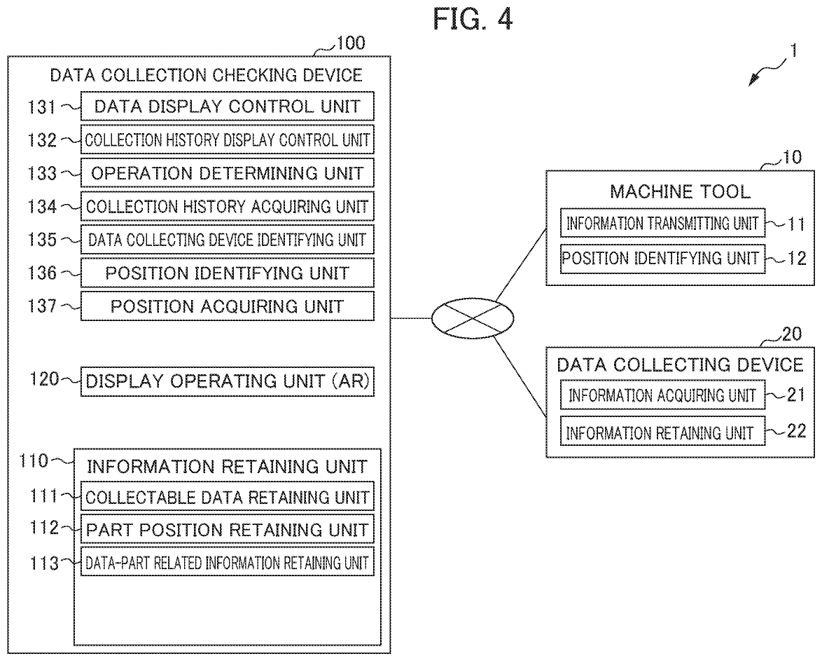

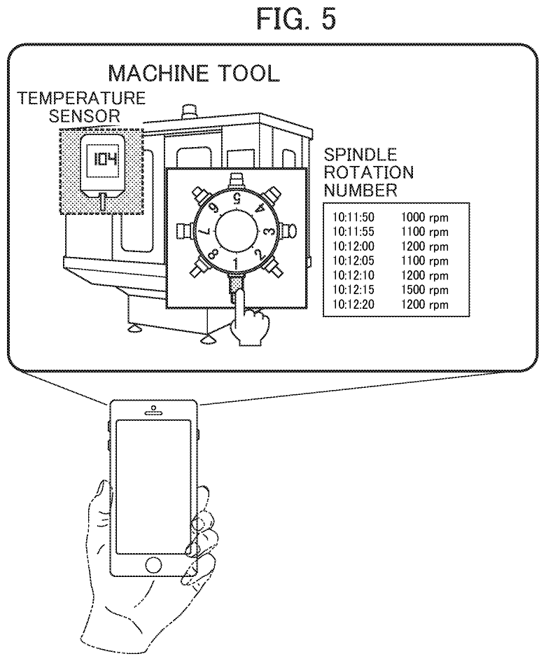

FIG. 4 is a diagram showing a configuration of a data collecting system including a data collection checking device of a machine tool according to a second embodiment. FIG. 5 is a diagram showing an example of display by the data collection checking device of the machine tool according to the second embodiment. In the data collection checking device 100 shown in FIG. 4, as compared with the data collection checking device 100 shown in FIG. 1, the display operating unit 120 is different. Furthermore, the data collection checking device 100 shown in FIG. 4 differs from the data collection checking device 100 shown in FIG. 1 in that the former includes a data collecting device identifying unit 135, a position identifying unit 136, and a position acquiring unit 137.

The display operating unit 120 includes a display device such as a liquid crystal display to display an augmented reality (AR) in which virtual reality is superimposed on the real world. The display operating unit 120 performs display by superimposing a virtual object on a machine tool in the real world which is projected by an imaging device such as a camera. In addition, the display operating unit 120 displays an object indicating the data collecting device.

In addition, the display operating unit 120 includes an operation device such as a touch panel, and detects operation by an operator.

The data collecting device identifying unit 135 searches and identifies the data collecting device collecting the data of the machine tool displayed on the display operating unit 120. Details of the data collecting device identifying unit 135 will be described later.

The position identifying unit 136 identifies the position of the machine tool in the real world displayed on display operating unit 120, for example, by radio wave intensity positioning of RFID or beacon provided in the machine tool.

The position acquiring unit 137 acquires position information of the machine tool from the machine tool 10 (e.g., the position identifying unit 12).

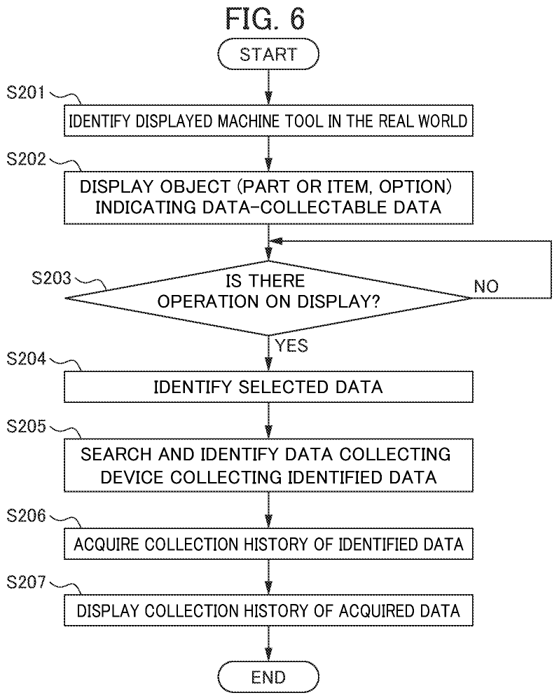

Next, with reference to FIG. 6, a description will be given of a data collection checking operation by a data collection checking device of a machine tool according to the second embodiment. FIG. 6 is a flowchart of data collection checking operation by the data collection checking device of the machine tool according to the second embodiment.

First, an operator projects a desired machine tool on the display operating unit 120 by an imaging device such as a camera. Then, the position identifying unit 136 identifies the position of the machine tool in the real world displayed on the display operating unit 120, for example, by radio wave intensity positioning of the RFID or beacon provided in the machine tool. Thus, the position identifying unit 136 can identify the machine tool in the real world displayed on the display operating unit 120 on the basis of the position information of the machine tool acquired by the position acquiring unit 137 (S201).

Next, the data display control unit 131 displays, on the display operating unit 120, a virtual object relating to data-collectable data in a machine tool on the basis of the data-collectable data retained in the collectable data retaining unit 111, the position of a part corresponding to the data-collectable data retained in the part position retaining unit 112, and the data-part relation information retained in the data-part related information retaining unit 113 (S202).

Next, the operation determining unit 133 determines operation of the operator with respect to the virtual object relating to the data displayed on the display operating unit 120 (S203). If there is no operation by the operator, the processing returns to Step S203.

On the other hand, for example, the operator performs an operation of tapping a virtual object relating to the desired data displayed on the display operating unit 120. Then, the operation determining unit 133 identifies the data selected by the operator (S204).

Next, the data collecting device identifying unit 135 searches and identifies the data collecting device collecting the selected data from the identified machine tools in the network (S205). For example, the data collecting device identifying unit 135 may search a data collecting device by inquiring with the machine tool and causing the machine tool to confirm the communication contents with the data collecting device. Alternatively, the data collecting device identifying unit 135 may search the data collecting device by inquiring with an external information retaining unit (e.g., a database or router) and acquiring the communication contents or correlation between the retained machine tool and the data collecting device.

Next, the collection history acquiring unit 134 acquires the collection history of the selected data from a searched data collecting device 20 (e.g., the information retaining unit 22) (S206).

Next, the collection history display control unit 132 displays the collection history of the acquired data to the display operating unit 120 (S207). In the example of FIG. 5, the collection history of the data is displayed near an object of the data selected by the operator. It should be noted that, in a case in which the data is collected by the device performing a plurality of data collection, the collection history of these data may be combined to be displayed.

As described above, even in the data collection checking device 100 of the machine tool of the second embodiment, it is possible to obtain the same advantages as the data collection checking device 100 of the machine tool of the first embodiment.

### Modification Example of the Second Embodiment

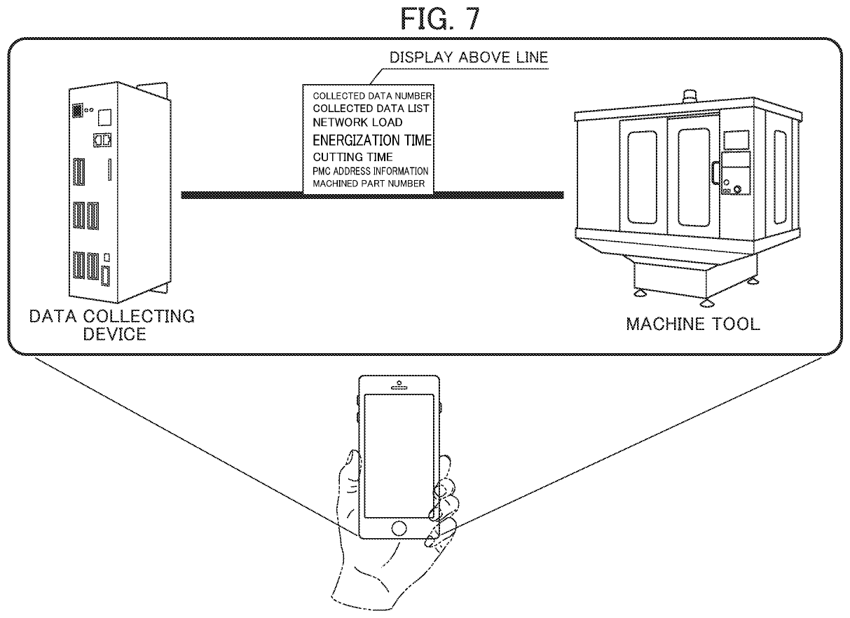

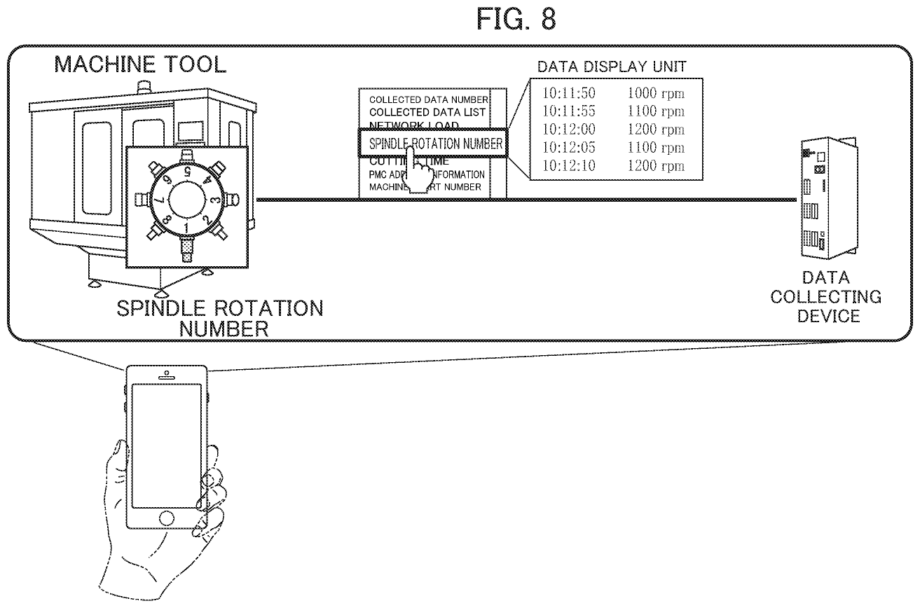

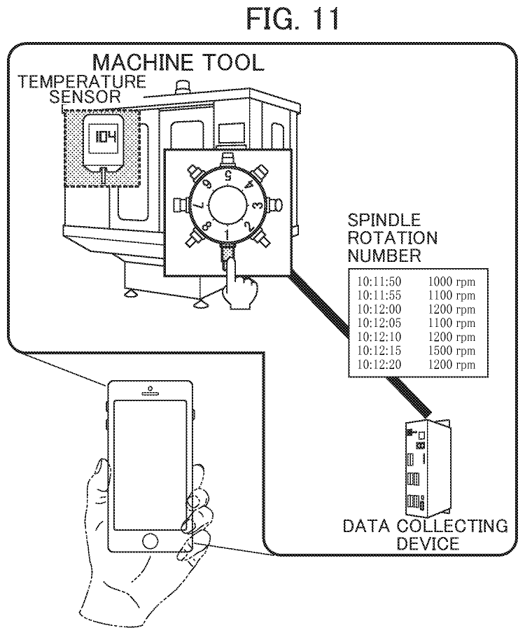

FIGS. 7 and 8 are diagrams each showing an example of display by the data collection checking device of the machine tool according to a modification example of the second embodiment. FIG. 11 is a flowchart of a data collection checking operation by the data collection checking device of the machine tool according to the modification example of the second embodiment.

First, the operator projects a desired machine tool on the display operating unit 120 by an imaging device such as a camera, and taps a machine tool in the real world displayed on the display operating unit 120. Then, the operation determining unit 133 identifies the machine tool selected by the operator.

Next, the position identifying unit 136 identifies the position of the machine tool in the real world displayed on the display operating unit 120, for example, by radio wave intensity positioning of the RFID or beacon provided in the machine tool. Thus, the position identifying unit 136 can identify the machine tool in the real world displayed on the display operating unit 120 on the basis of the position information of the machine tool acquired by the position acquiring unit 137 (S201).

Furthermore, the operator projects a desired data collecting device on the display operating unit 120 by an imaging device such as a camera, and taps a data collecting device in the real world displayed on the display operating unit 120. Then, the operation determining unit 133 identifies the data collecting device selected by the operator.

Next, the data collecting device identifying unit 135 searches and identifies the data collecting device collecting the selected data from the identified machine tool in the networks (S211).

Next, the data collecting device identifying unit 135 determines whether there is a data collection relationship between the identified machine tool and the identified data collecting device (S212). If there is no data collection relationship, the processing returns to Step S201.

On the other hand, in a case in which there is a data collection relationship, the collection history acquiring unit 134 acquires the collection history of the selected data from the identified data collecting device 20 (e.g., the information retaining unit 22) (S206).

The data display control unit 131 displays the items (objects) of the acquired data on the display operating unit 120 (S202). In the example of FIG. 7, the data display control unit 131 displays an object indicating the correlation between the identified machine tool and the identified data collecting device, for example, a correlation line. The data display control unit 131 may display a correlation line in a distinguishable manner in accordance with the presence or absence of the data collection. For example, a green correlation line may be displayed when the data is being collected, and a black correlation line may be displayed when the data is not being collected. In this case, the data display control unit 131 may display the item of the acquired data (object), for example, an option of the item of data, near the correlation line

Next, the operation determining unit 133 determines operation of the operator with respect to the items (objects) of the data displayed on the display operating unit 120 (S203). If there is no operation by the operator, the processing returns to Step S203.

On the other hand, for example, the operator performs an operation of tapping an item (object) of the desired data displayed on the display operating unit 120. Then, the operation determining unit 133 identifies the item of the data selected by the operator (S204).

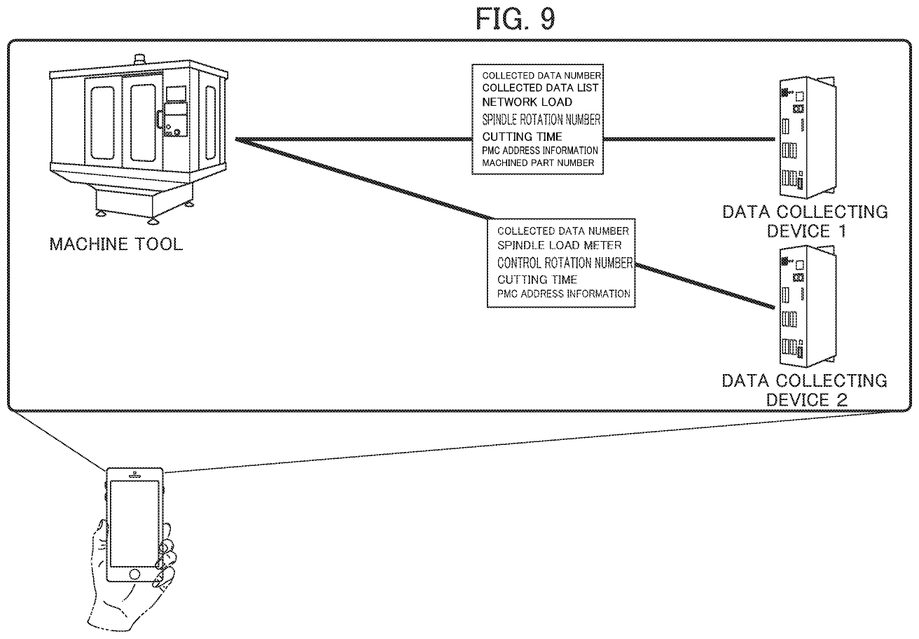

Next, the collection history display control unit 132 displays, on the display operating unit 120, the collection history of the data of the selected items on the basis of the collection history of the acquired data (S207). In the example of FIG. 8, the collection history of the data is displayed near the correlation line. Thus, by displaying the collection history of the data on the correlation line connecting the machine tool and the data collecting device, it is possible for the operator to easily and intuitively recognize the collection history of the data between which machine tool and which data collecting device. Furthermore, even when the data of the machine tool is collected in a plurality of data collecting devices as shown in FIG. 9, the data can be easily distinguished.

At this time, the data display control unit 131 may display, in a highlighted manner, an object indicating a part corresponding to the selected data, near the position of the part in the machine tool in the real world, or near the collection history of the data. According to this, the collection history of the data can be recognized easily and intuitively by the operator.

It should be noted that, in the second embodiment, as shown in FIG. 11, it may be configured so as to display an object such as a correlation line indicating the correlation between the machine tool and the data collecting device, and display the collection history of the data near the correlation line.

Although the embodiments of the present invention have been described above, the present invention is not limited to the embodiments described above, and various modifications and variations are possible. For example, in the above-described embodiment, a data collection checking device for checking the data collection status when the data of the machine tool is being collected in the data collecting device is exemplified; however, the present embodiment is not limited thereto. The data collection checking device of the present embodiment is applicable to various devices for checking the data collection status when collecting data of various industrial machines in the data collecting device.

### EXPLANATION OF REFERENCE NUMERALS

1 data collection system
10 machine tool
11 information transmitting unit
12 position identifying unit
20 data collecting device
21 information acquiring unit
22 information retaining unit
100 data collection checking device
110 information retaining unit
111 collectable data retaining unit
112 part position retaining unit
113 data-part related information retaining unit
120 display operating unit
131 data display control unit
132 collection history display control unit
133 operation determining unit
134 collection history acquiring unit
135 data collecting device identifying unit
136 position identifying unit
137 position acquiring unit

What is claimed is:

1. A data collection checking device of an industrial machine which performs checking of a data collection status when data of the industrial machine are being collected in a data collecting device, the data collection checking device comprising:
a display unit that displays an object indicating the industrial machine;
a data display control unit that displays, on the display unit, a virtual object indicating the data which are collectable in the industrial machine;
an operation determining unit that determines operation of an operator with respect to the virtual object indicating the data displayed on the display unit, and identifies the data;
a collection history acquiring unit that acquires a collection history of the identified data; and
a collection history display control unit that displays, on the display unit, the collection history of the acquired data.

2. A data collection checking device of an industrial machine which performs checking of a data collection status when data of the industrial machine are being collected in a data collecting device, the data collection checking device comprising:
a display unit that displays augmented reality in which virtual reality is superimposed on the real world;
an industrial machine identifying unit that identifies the industrial machine in the real world displayed on the display unit;
a data display control unit that displays, on the display unit, a virtual object relating to the data which are collectable in the industrial machine identified by the industrial machine identifying unit;
an operation determining unit that determines an operation of an operator with respect to a virtual object indicating the data displayed on the display unit, and identifies the data;
a collection history acquiring unit that acquires a collection history of the identified data; and
a collection history display control unit that displays, on the display unit, the collection history of the acquired data.

3. A data collection checking device of an industrial machine which performs checking of a data collection status when data of the industrial machine are being collected in a data collecting device, the data collection checking device comprising:
a display unit that displays augmented reality in which virtual reality is superimposed on the real world;
an industrial machine identifying unit that identifies the industrial machine in the real world displayed on the display unit;
a collection history acquiring unit that acquires a collection history of the data that is being collected in the industrial machine identified by the industrial machine identifying unit;
a data display control unit that displays, on the display unit, a virtual object relating to the data acquired by the collection history acquiring unit;
an operation determining unit that determines operation of an operator with respect to a virtual object indicating the data displayed on the display unit, and identifies the data; and
a collection history display control unit that displays, on the display unit, a collection history of the data identified by the operation determining unit on a basis of the collection history of the data acquired by the collection history acquiring unit.

4. The data collection checking device of the industrial machine according to claim 1, wherein the data display control unit displays, on the display unit, an object indicating correlation between the industrial machine and a correlated data collecting device, and
the collection history display control unit displays the collection history of the data near the object indicating the correlation.

5. The data collection checking device of the industrial machine according to claim 2, wherein the data display control unit displays, on the display unit, an object indicating correlation between the industrial machine and a correlated data collecting device, and
the collection history display control unit displays the collection history of the data near the object indicating the correlation.

6. The data collection checking device of the industrial machine according to claim 3, wherein the data display control unit displays, on the display unit, an object indicating correlation between the industrial machine and a correlated data collecting device, and
the collection history display control unit displays the collection history of the data near the object indicating the correlation.
